(19) United States
(12) Patent Application Publication
(10) Pub. No.: US 2013/0283138 A1
(43) Pub. Date: Oct. 24, 2013

(54) METHOD FOR CREATING KNOWLEDGE MAP

(71) Applicants: Wo Hai Tao, (US); Tsai Pei HSun, (US)

(72) Inventors: Wo Hai Tao, (US); Tsai Pei HSun, (US)

(21) Appl. No.: 13/610,534

(22) Filed: Sep. 11, 2012

(30) Foreign Application Priority Data
Apr. 24, 2012 (TW) 101114493

(51) Int. Cl. G06F 17/00

(52) U.S. Cl. 715/205

(57) ABSTRACT

A method for creating a knowledge map is revealed. The method includes several steps. Get a plurality of electronic chapters and arrange the electronic chapters in sequence to obtain a knowledge node sequence list. Then the knowledge node sequence list is stored in a memory and a plurality of knowledge nodes of the knowledge node sequence list is connected to the electronic chapters by hyperlinks. Next compile a list property of the knowledge node sequence list and a plurality of node properties of the knowledge nodes to create the knowledge map that shows connections and structure of knowledge. The knowledge connections are visualized and graphically organized in the knowledge map to promote thinking and learning.

### BACKGROUND OF THE INVENTION

1. Field of the Invention

The present invention relates to a method for creating a knowledge map, especially to a method in which a plurality of electronic chapters obtained is sequenced to get a knowledge node sequence list. Then the electronic chapters are connected to a plurality of knowledge nodes of the knowledge node sequence list by hyperlinks so as to create a knowledge map.

2. Description of Related Art

Due to spread of printing and fast development of internet, human society has entered an era of knowledge explosion. Everyone needs to deal with a large amount of information. After being screened, a useful part of the information is left and transformed into knowledge. The knowledge is organized for efficient retrieval and applications. For persons or organizations, knowledge management is critical to decision making and project execution.

The concept of knowledge map is proposed by Davenport and Prusak in 1998. Knowledge is divided into a plurality of meaningful units. Then use these units as different nodes to deliver a knowledge map. Thus abstract concepts are converted into concrete images to enhance comprehension and utilization. The knowledge map can be constructed to point to knowledge, like a directory, but does not contain it. It helps users quickly and easily locate the desired knowledge and indicates the relationships among the desired knowledge and other units for knowledge management.

Thus the present invention provides a method for creating a knowledge map that introduces knowledge management concept and applies the concept to managing electronic content. The method includes a plurality of steps. Firstly get a plurality of electronic chapters and arrange the electronic chapters in a linear form or a network structure according to logic of the knowledge map going to be created. Thus a knowledge node sequence list is set up, showing relationships among knowledge nodes formed by concepts extracted from each electronic chapter. Through creation of the knowledge map, the intangible knowledge structure and logic are transformed into a solid knowledge node sequence list and the knowledge map reflects learning purpose and learning strategy the compiler recommended. The hidden message and concrete knowledge can also be distributed in a diagram. While audience in contact with the knowledge node sequence list, they make a contrast between a list sequence of the knowledge node sequence list and a plurality of node properties of the knowledge nodes so as to quickly get an overview of a plurality of electronic chapters connected to the knowledge nodes and logical relationships among the knowledge nodes. By connections of the knowledge nodes and reading of the electronic chapters, users get the knowledge.

Moreover, the knowledge nodes are connected to at least one explanation information to assist the audience in learning the electronic chapters. The electronic chapters and the knowledge node sequence list are stored in a memory. Moreover, at least one mark information and at least one note information are set up in the memory. The mark information and the note information help the audience understand and memorize the knowledge or share marks or notes with others. At least one discussion information, at least one question information, and at least one answer information are set up in the memory for communication and information exchange related to the knowledge nodes. Furthermore, a permission property is contrasted with a permission information coming from a progress information so as to control the access the audience have to the knowledge node sequence list, the knowledge nodes, the electronic chapters connected to the knowledge nodes, and a plurality explanation information connected to the knowledge nodes. In addition, a frequency property is generated for reflecting frequency of use of the knowledge node sequence list. Due to visualization and graphic organization of the knowledge connections in the knowledge map as well as learning materials and learning aids distributed along with the knowledge map, thinking and learning are enhanced.

### SUMMARY OF THE INVENTION

Therefore it is a primary object of the present invention to provide a method for creating a knowledge map in which a plurality of electronic chapters are arranged in sequence to get a knowledge node sequence list for reflecting compiler's purpose and strategic logic of making the knowledge map. The content of the electronic chapters are compiled, sequenced and connected according to compilers' thoughts so as to form the knowledge map.

It is another object of the present invention to provide a method for creating a knowledge map in which a plurality of electronic books is divided to get a plurality of electronic chapters and use the electronic chapters to produce a knowledge map. The knowledge map is not restricted by the respective electronic book or the chapter order available now.

It is a further object of the present invention to provide a method for creating a knowledge map which is applied to producing a plurality of electronic books of a plurality of electronic chapters. The method involves scanning of a plurality of physical books and conversion of printed words into digital content. Thus the knowledge map is not limited by the physical books, getting easier to be compiled and distributed.

It is a further object of the present invention to provide a method for creating a knowledge map in which a plurality of knowledge nodes is added with at least one explanation information in the form of text, audio or video for the expansion of or the supplement to at least one electronic chapter in the knowledge nodes. Thus the audience can learn the electronic chapters contained in knowledge nodes.

It is a further object of the present invention to provide a method for creating a knowledge map in which a plurality of knowledge nodes is added with at least one mark information or at least one note information so that the audience can make a mark or a note on the electronic chapters or the explanation information contained in the knowledge nodes conveniently. Moreover, the mark information and the note information help the audience understand and memorize the electronic chapters or the explanation information contained in the knowledge nodes, or help the audience share marks or notes with others.

It is a further object of the present invention to provide a method for creating a knowledge map in which a plurality of knowledge nodes is added with at least one discussion information or at least one question information, and at least one answer information corresponding to the discussion information/the question information for user's communication and information exchange related to the knowledge nodes.

It is a further object of the present invention to provide a method for creating a knowledge map in which a list property of a knowledge node sequence list contains a permission property for control of the access that the audience have to the knowledge node sequence list, the knowledge nodes contained in the knowledge node sequence list, the electronic chapters, the explanation information, the mark information, the note information, the discussion information, the question information, or the answer information connected to the knowledge nodes.

It is a further object of the present invention to provide a method for creating a knowledge map in which a progress information is generated in a memory according to the electronic chapters or the explanation information of the knowledge nodes the audience read. The progress information represents the audience's learning condition. Or the progress information is converted into a permission information that is in contrast with the permission property so that the access the audience have to the knowledge node sequence list is determined according to the progress of the audience.

It is a further object of the present invention to provide a method for creating a knowledge map in which a frequency property is generated in a memory according to the electronic chapters or the explanation information of the knowledge nodes the audience read. Thus frequency of use of the knowledge map is learned and the content of the knowledge map is modified or deleted in response to the frequency of use.

It is a further object of the present invention to provide a method for creating a knowledge map in which a knowledge node is expanded into a sub-knowledge node sequence list so as to show knowledge structure and logical relationships in details.

In order to achieve the above objects, a method for creating a knowledge map includes a plurality steps. Firstly, obtain a plurality of electronic chapters and sequence the electronic chapters freely so as to get a knowledge node sequence list. The knowledge node sequence list is stored in a memory and a plurality of knowledge nodes in the knowledge node sequence list is connected to the electronic chapters by hyperlinks. Next compile a list property of the knowledge node sequence list and a plurality of node properties of the knowledge nodes. Thus the knowledge node sequence list shows the knowledge structure, the purpose of creating the knowledge map and the learning strategy.

The electronic chapters are obtained by dividing a plurality of electronic books. This breaks the limits of the chapters of the electronic books available now. A plurality of physical books is scanned by a scanner to get the electronic books. The printed words of the physical books are converted into digital format. Not like books in print that require storage space and having difficulties in compilation and replication, the electronic books are easy to copy and shelf space saved. The electronic chapters obtained are arranged in a linear form or a network structure to get a knowledge node sequence list. The knowledge node sequence list shows compiler's recognition of knowledge structure and preferred learning strategy. A plurality of knowledge nodes in the knowledge node sequence list is connected to the electronic chapters by hyperlinks to avoid repetitive copy of the electronic chapters in the same memory. The storage space is reduced and the compiler can use and connect the electronic chapters freely. A list property related to the knowledge node sequence list and a plurality of node properties related to the knowledge nodes are freely compiled to allow the audience to learn general content of the knowledge node sequence list and the knowledge nodes.

Moreover, the knowledge nodes are connected to at least one explanation information in the form of text, audio or video by hyperlinks to help the audience understand the electronic chapters the knowledge nodes contain. Or the explanation information is used as a supplementary to the electronic chapters. At least one mark information or at least one note information is connected to the knowledge nodes by hyperlinks so that the audience can make marks or notes relates to the electronic chapters contained in the knowledge nodes or the explanation information for assistance in understanding, memorizing, or sharing the content with others. At least one discussion information, at least one question information, or at least one answer information is connected to the knowledge nodes by hyperlinks so that uses can discuss and exchange information about the knowledge nodes. A permission property is set in the knowledge node sequence list for control of the access that the audience have to the knowledge node sequence list and the related content. A progress information is stored in the memory and is for reflecting learning state of the audience. Or the progress information is converted to a permission information and then the permission information is in contrast to the permission property to determine whether the audience can read the knowledge node sequence list and the related content. A frequency property is generated according to the audience's reading of the electronic chapters or the explanation information of the knowledge nodes so that the audience, the compiler or the manager can grasp the use frequency of the knowledge node sequence list. They can also compile and modify the properties, the nodes, the electronic chapters or the explanation information, or delete the knowledge node sequence list according to the use frequency. In addition, the knowledge nodes can be further expanded into a sub-knowledge node sequence list having a plurality of sub-knowledge nodes and a plurality of electronic chapters hyperlinked to the sub-knowledge nodes for reflection of detailed knowledge structure and logical relationships in the knowledge map. In the knowledge map created by the method of the present invention, logical connections of the knowledge are visualized and graphically organized. Moreover, learning materials including the electronic chapters and explanation information and learning aids such as marks, notes, and discussion information are distributed along with the knowledge map. Therefore, the audience's thinking and learning are nurtured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of an embodiment according to the present invention;

FIG. 2 is a schematic drawing showing connection of an embodiment according to the present invention;

FIG. 3 is a flow chart showing steps of another embodiment according to the present invention;

FIG. 4 is a schematic drawing showing connection of another embodiment according to the present invention;

FIG. 5 is a schematic drawing showing sequence of knowledge nodes of a further embodiment according to the present invention.

### DETAILED DESCRIPTION OF THE PREFERRED EMBODIMENT

A method for creating a knowledge map features on that a plurality of electronic chapters are arranged in a linear form or a network structure according to compiler's thoughts so as to get a knowledge node sequence list. A plurality of knowledge nodes in the sequence list is hyperlinked to the electronic chapters. Thus compilation of the knowledge map is not limited by physical books or electronic books (e-books) available now. The knowledge map shows logical relationships among the plurality of knowledge nodes of the knowledge node sequence list. The intangible knowledge structure is transformed into a solid diagram so as to have some idea of compiler's purpose and the recommended learning strategy. Moreover, the knowledge nodes can also be connected to at least one explanation information, at least one mark information, at least one note information, at least one discussion information, at least one question information, or at least one answer information for expanding or supplementing the electronic chapters, making a mark or a note on the electronic chapters and the explanation information contained in the knowledge nodes, or carrying on a discussion about the knowledge nodes. The knowledge node sequence list is set to have a permission property. The permission property is in contrast to a permission information transformed from a progress information so as to control the access that the audience have to the knowledge node sequence list and the related content. When the audience read the electronic chapters and the explanation information hyperlinked to the knowledge nodes in the knowledge node sequence list, a frequency property that reflects frequency of use of the knowledge node sequence list is generated to facilitate management. Furthermore, the knowledge node can be expanded into a sub-knowledge node sequence list to express more detailed knowledge structure and logical relationships in the knowledge map.

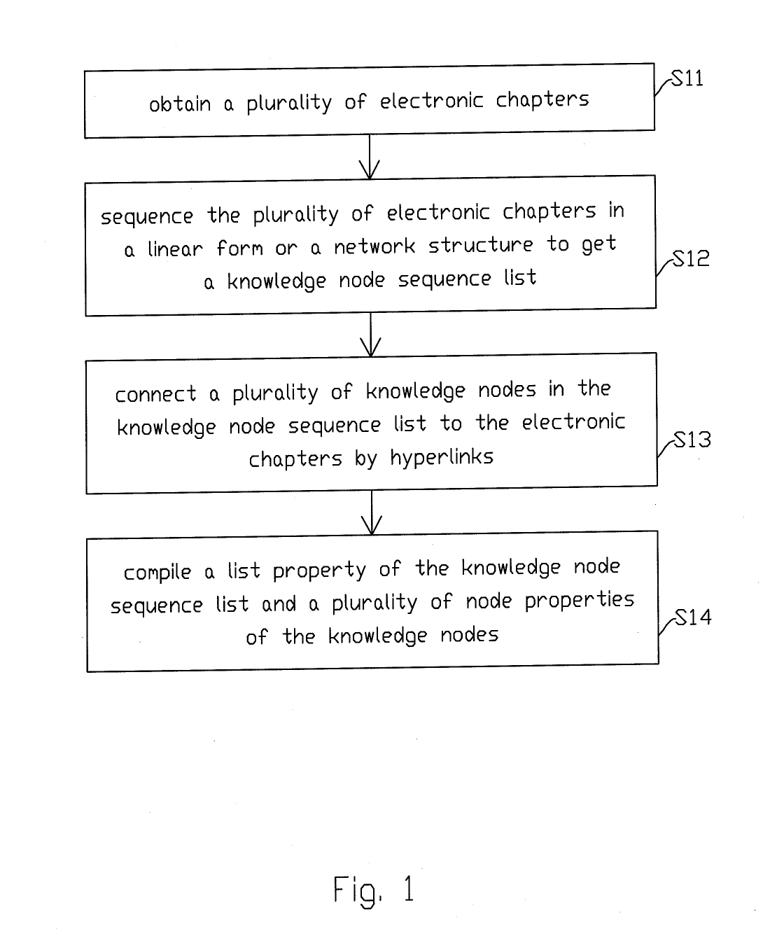

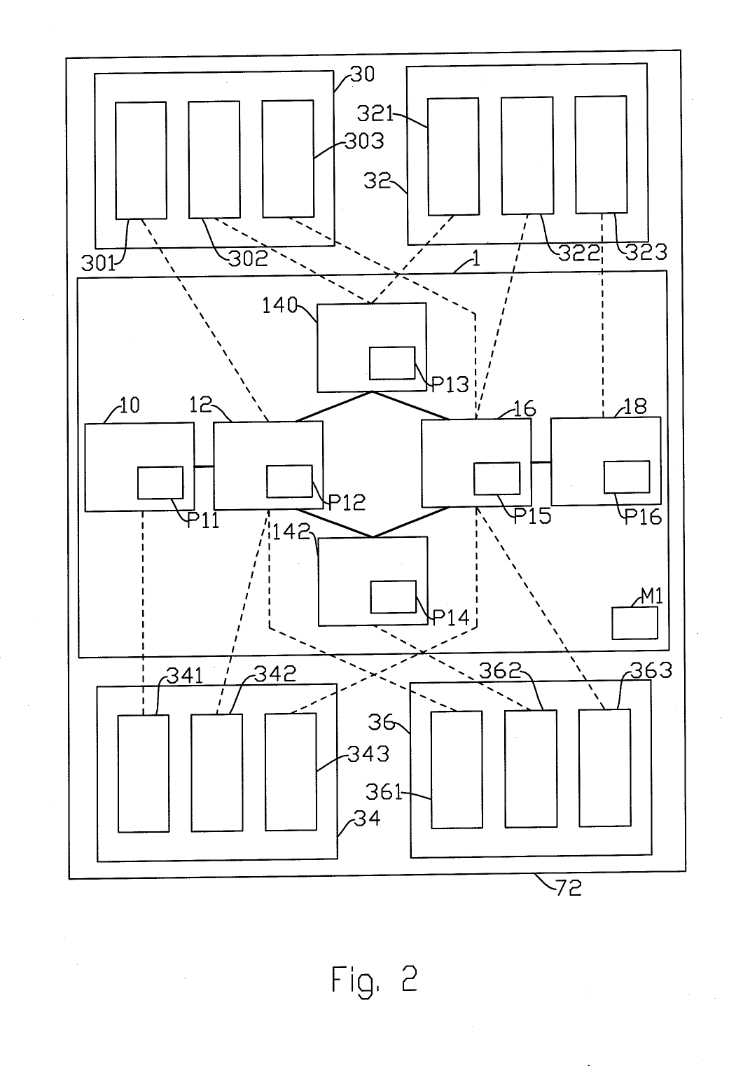

Refer to FIG. 1 and FIG. 2, an embodiment of a method for creating a knowledge map according to the present invention includes following steps
S11: obtain a plurality of electronic chapters.
S12: sequence the plurality of electronic chapters in a linear form or a network structure to get a knowledge node sequence list.
S13: connect a plurality of knowledge nodes in the knowledge node sequence list to the electronic chapters by hyperlinks.
S14: compile a list property of the knowledge node sequence list and a plurality of node properties of the knowledge nodes.

As shown in FIG. 2, a first electronic book (e-book) 30, a second e-book 32, a third e-book 34, and a fourth e-book 36 are respectively divided into a 1-1 electronic chapter 301, a 1-2 electronic chapter 302, a 1-3 electronic chapter 303, a 2-1 electronic chapter 321, a 2-2 electronic chapter 322, a 2-3 electronic chapter 323, a 3-1 electronic chapter 341, a 3-2 electronic chapter 342, a 3-3 electronic chapter 343, a 4-1 electronic chapter 361, a 4-2 electronic chapter 362, and a 4-3 electronic chapter 363. Arrange these electronic chapters in sequence to get a knowledge node sequence list 1. The knowledge node sequence list 1 includes six knowledge nodes that respectively are introduction to software testing 10, software test planning 12, software testing method 140, software test design 142, software test execution 16, and software test summary 18. The introduction to software testing 10 is connected to the software test planning 12 while the software test planning 12 is connected to both the software testing method 140 and the software test design 142. The software testing method 140 and the software test design 142 are respectively connected to the software test execution 16. The software test execution 16 is connected to the software test summary 18. The introduction to software testing 10 is connected to the 3-1 electronic chapter 341 by a hyperlink. The software test planning 12 is hyperlinked to the 1-1 electronic chapter 301, the 3-2 electronic chapter 342, and the 4-1 electronic chapter 361. The software testing method 140 is connected to the 1-2 electronic chapter 302 and the 2-1 electronic chapter 321 by hyperlinks while the software test design 142 is hyperlinked to the 4-2 electronic chapter 362. As to the software test execution 16, it is connected to the 3-3 electronic chapter 343 and the 4-3 electronic chapter 363 by hyperlinks. The software test summary 18 is hyperlinked to the 2-3 electronic chapter 323. The knowledge node sequence list 1 includes a list property M1. The introduction to software testing 10 includes a first node property P11 and the software test planning 12 includes a second node property P12. Similarly, the software testing method 140 is having a third node property P13, the software test design 142 is including a fourth node property P14, the software test execution 16 is with a fifth node property P15, and the software test summary 18 is having a sixth node property P16. The e-books, the electronic chapters, the knowledge node sequence list 1, and the knowledge nodes are all stored in a memory 72.

The knowledge node sequence list 1 is created by dividing the four e-books 30, 32, 34, 36 into twelve electronic chapters 301, 302, 303, 321, 322, 323, 341, 342, 343, 361, 362, 363 and sequencing the twelve electronic chapters. Thus the creation of the knowledge map is not restricted by the e-books available now. The knowledge node sequence list 1 shows logical relationships among the knowledge nodes 10, 12, 140, 142, 16, and 18. The list property M1 and the node properties P11, P12, P13, P14, P15, and P16 help the audience to understand general contents of the knowledge node sequence list 1 and the knowledge nodes 10, 12, 140, 142, 16, and 18.

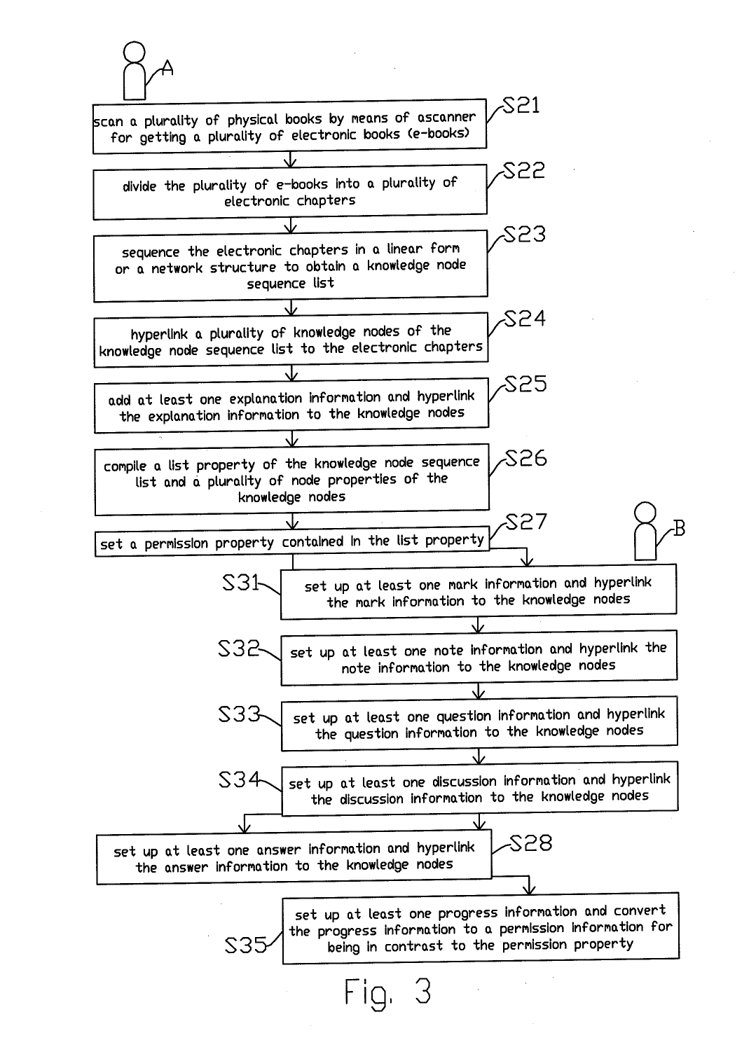

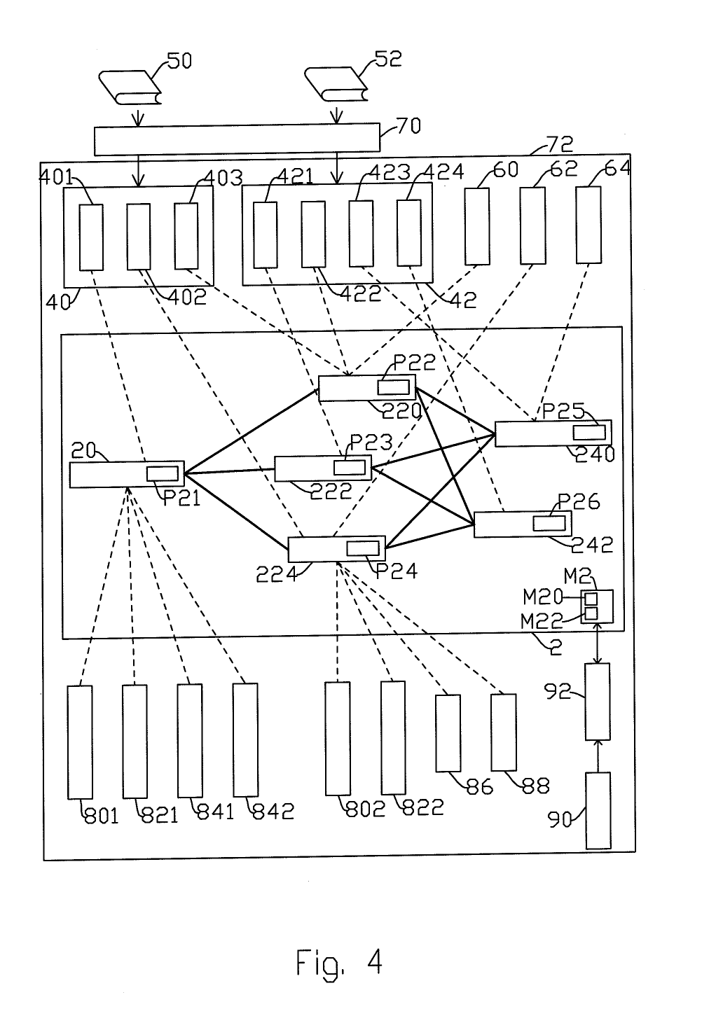

Refer to FIG. 3 and FIG. 4, another embodiment of the present invention showing steps and connection/relationship is revealed. As shown in the FIG. 3, a method for creating a knowledge map includes following steps:
S21: scan a plurality of physical books by means of a scanner for getting a plurality of electronic books (e-books).
S22: divide the plurality of e-books into a plurality of electronic chapters.
S23: sequence the electronic chapters in a linear form or a network structure to obtain a knowledge node sequence list.
S24: hyperlink a plurality of knowledge nodes of the knowledge node sequence list to the electronic chapters.
S25: add at least one explanation information and hyperlink the explanation information to the knowledge nodes.
S26: compile a list property of the knowledge node sequence list and a plurality of node properties of the knowledge nodes.
S27: set a permission property contained in the list property;
S31: set up at least one mark information and hyperlink the mark information to the knowledge nodes.
S32: set up at least one note information and hyperlink the note information to the knowledge nodes.
S33: set up at least one question information and hyperlink the question information to the knowledge nodes.
S34: set up at least one discussion information and hyperlink the discussion information to the knowledge nodes.
S28: set up at least one answer information and hyperlink the answer information to the knowledge nodes
S35: set up at least one progress information and convert the progress information to a permission information for being in contrast to the permission property.

The step S21 to the step S28 are performed by a first user A while the step S31 to the step S35 are run by a second user B.

As shown in FIG. 4, a first physical book 50 and a second physical book 52 are respectively scanned and converted to a first electronic book 40 and a second electronic book 42 by a scanner 70. The electronic books 40, 42 are divided into a plurality of electronic chapters including a 1-1 electronic chapter 401, a 1-2 electronic chapter 402, a 1-3 electronic chapter 403, a 2-1 electronic chapter 421, a 2-2 electronic chapter 422, a 2-3 electronic chapter 423, and a 2-4 electronic chapter 424. The electronic chapters are compiled to get a knowledge node sequence list 2. The knowledge node sequence list 2 includes six knowledge nodes that respectively are introduction to computer science 20, assembly language 220, data structure 222, programming language 224, computer organization 240, and operating system 242. The computer science 20 is connected to the assembly language 220, the data structure 222 and the programming language 224 while the assembly language 220, the data structure 222 and the programming language 224 are respectively connected to both the computer organization 240 and the operating system 242 so as to form a network structure. The computer science 20 is hyperlinked to the 1-1 electronic chapter 401 and the assembly language 220 is hyperlinked to the 1-3 electronic chapter 403 and the 2-2 electronic chapter 422. The data structure 222 is hyperlinked to the 2-1 electronic chapter 421 while the programming language 224 is hyperlinked to the 1-2 electronic chapter 402. The computer organization 240 is hyperlinked to the 2-3 electronic chapter 423 while the operating system 242 is hyperlinked to the 2-4 electronic chapter 424. Three pieces of explanation information including an explanation text 60, an explanation speech 62 and an explanation video 64 are set up. The explanation text 60 is hyperlinked to the assembly language 220, the explanation speech 62 is hyperlinked to the programming language 224 and the explanation video 64 is hyperlinked to the computer organization 240. The knowledge node sequence list 2 includes a list property M2 while the list property M2 consists of a permission property M20 and a frequency property M22. The introduction to computer science 20 includes a first node property P21, the assembly language 220 includes a second node property P22, the data structure 222 includes a third node property P23, the programming language 224 includes a fourth node property P24, the computer organization 240 includes a fifth node property P25, and the operating system 242 includes a sixth node property P26. Furthermore, a first mark information 801, a first note information 821, a first discussion information 841 and a second discussion information 842 are set up and are hyperlinked to the introduction to computer science 20. Similarly, a second mark information 802, a second note information 822, a question information 86 and an answer information 88 are set up and are hyperlinked to the programming language 224. A progress information 90 is set up and is converted to a permission information 92 that is in contrast to the permission property M20 for control of the access of the knowledge node sequence list 2 and the reading of the six knowledge nodes 20, 220, 222, 224, 240, and 242. Those e-books, the electronic chapters, the knowledge node sequence list 2, the knowledge nodes, those mark information, those note information, those discussion information, the question information 86, the answer information 88, the progress information 90 and the permission information 92 are all stored in a memory 72.

By the scanner 70, the physical books 50, 52 are converted into the electronic books 40, 42. The paper/documents are converted into electronic format for convenient compilation and distribution. Then the electronic books 40, 42 are divided into the electronic chapters 401, 402, 403, 421, 422, 423, and 424 that are compiled in sequence to form a knowledge node sequence list 2. Thus the creation of the knowledge map is not restricted by physical books and electronic books available now. The knowledge node sequence list 2 represents logical relationships among the knowledge nodes 20, 220, 222, 224, 240, 242. The set-up of the explanation information 60, 62, 64 helps the audience to understand the electronic chapters 403, 422, 402, 423 connected to the same knowledge node 220, 224, 240. The list property M2 and the node properties P21, P22, P23, P24, P25, and P26 help the audience to learn about the content of the knowledge node sequence list 2 and the knowledge nodes 20, 220, 222, 224, 240, 242. As to the mark information 801,802 and the note information 821, 822 set up and connected to the knowledge nodes 20, 224, they help the audience use marks and notes to understand and memorize the content of the knowledge nodes 20, 224. The discussion information 841, 842, the question information 86, and the answer information are set up by different persons for being exchanged. The progress information 90 reminding the audience the reading progress can be converted to the permission information 92. Then the permission information 92 is in contrast to the permission property M20 to determine whether the audience can read the knowledge node sequence list or the knowledge nodes. In addition, the frequency property M22 reflects the frequency of the knowledge node sequence list 2 being used. Thus the compiler or a manager can determine whether the list property M2 and the node properties P21, P22, P23, P24, P25, P26 are going to be compiled, whether the number of the knowledge nodes 20, 220, 222, 224, 240, 242 is increased or decreased, whether the electronic chapters 401, 402, 403, 421, 422, 423, 424 and the explanation information 60, 62, 64 hyperlinked to the knowledge nodes 20, 220, 222, 224, 240, 242 are changed or not, or whether the permission property M20 is modified to turn off the knowledge node sequence list 2 and allow the knowledge node sequence list 2 unable to be read and to be deleted.

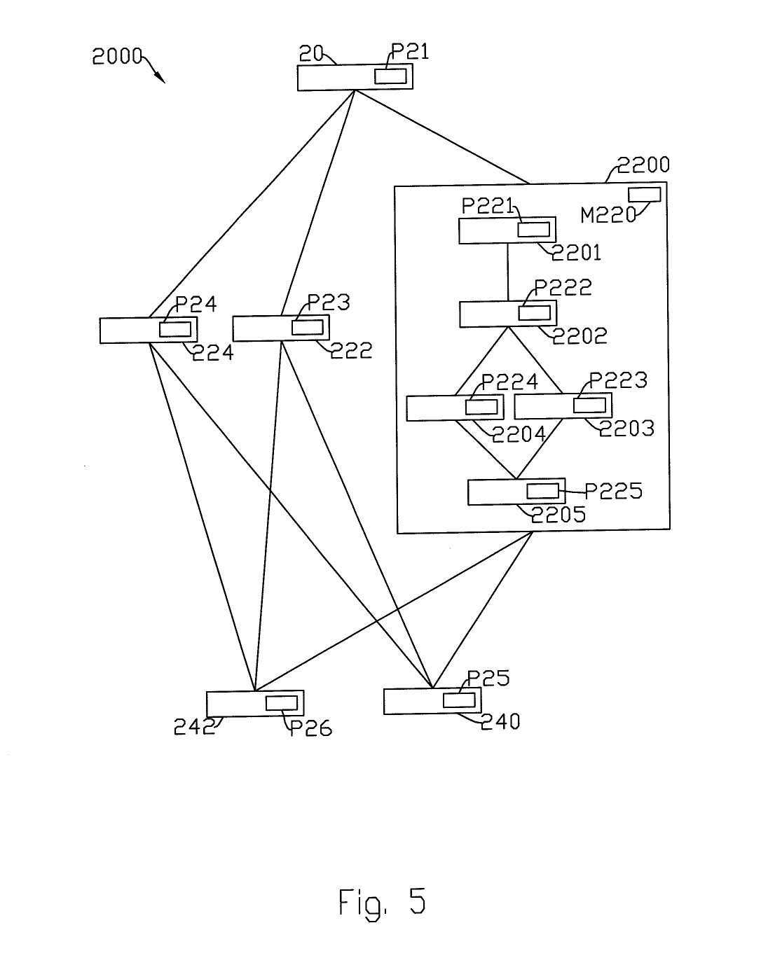

Refer to FIG. 5, a further embodiment of the present invention is revealed. As shown in figure, the difference between a knowledge node sequence list 2000 of this embodiment and the above one shown in FIG. 4 is in that this embodiment includes a sub-knowledge node sequence list 2200 instead of the knowledge node 220 in the FIG. 4. That means the knowledge node 220 is expanded into the sub-knowledge node sequence list 2200. The sub-knowledge node sequence list 2200 includes five sub-knowledge nodes having assembly language principle 2201, assembly language command 2202, subprogram 2203, macro 2204, and assembly language example 2205. The assembly language principle 2201 is connected to the assembly language command 2202 while the assembly language command 2202 is connected to both the subprogram 2203 and the macro 2204. The subprogram 2203 and the macro 2204 are connected to the assembly language example 2205. Thus a network connection is set up. The sub-knowledge node sequence list 2200 includes a sub-list property M220. The assembly language principle 2201 includes a first subnode property P221. Similarly, the assembly language command 2202 includes a second subnode property P222, the subprogram 2203 includes a third subnode property P223, the macro 2204 includes a fourth subnode property P224, and the assembly language example 2205 includes a fifth subnode property P225. These sub-knowledge nodes 2201, 2202, 2203, 2204, and 2205 can be hyperlinked to the related electronic chapters or explanation information (not shown in figure).

By expansion of the knowledge node 220 into the sub-knowledge node sequence list 2200, the sub-knowledge nodes of the assembly language 220 including the assembly language principle 2201, the assembly language command 2202, the subprogram 2203, the macro 2204, and the assembly language example 2205 are introduced so as to reflect details of knowledge structure and logical relationships in the knowledge node sequence list 2.

In summary, a method for creating a knowledge map of the present invention includes a plurality of steps. Firstly get a plurality of electronic books and divide the electronic books into a plurality of electronic chapters. Then the electronic chapters are sequenced freely to get a knowledge node sequence list. A plurality of knowledge nodes of the knowledge node sequence list is connected to the electronic chapters by hyperlinks. Thus documents printed on paper are converted to electronic forms for compilation and distribution. The compilation and distribution is not limited to physical books or electronic books. The knowledge map reflects compiler's purpose of creating the map, the recognition of the knowledge nodes of the knowledge map, and the preferred/recommended learning strategy. Compiling the list property of the knowledge node and the node properties of helps the audience get an overview of the knowledge node sequence list and the knowledge nodes. Moreover, explanation information is added so that the audience can understand the contents of the electronic chapters. The set-up of the mark information and the note information facilitates user's comprehension and memorization or their sharing of marks or notes with others.

The discussion information, the question information, and the answer information are set up for user's communication and information exchange. As to the progress information, it reflects learning state of users. And the progress information is able to be converted to the permission information for control of the access the users have to the knowledge node sequence list or the knowledge nodes. The frequency property reflects frequency of use of the knowledge node sequence list so as to modify or turn off the knowledge map. Furthermore, the knowledge node can be expanded into a sub-knowledge map by introduction of sub-knowledge nodes, the related electronic chapters and the explanation information so as to reflect detailed structure of the knowledge map. The audience can quickly get the knowledge node sequence list, the knowledge node, the electronic chapter, the explanation information, the mark information, the note information, the discussion information, the question information or the answer information they need by compilation of the list property, the node property or increasing/decreasing the knowledge nodes and the hyperlinked electronic chapters and explanation information together with search engines. At last, the knowledge map is ever evolving to meet needs and requirements of the audience through production, compilation, expansion, deletion and application of the knowledge map of the present invention.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method for creating a knowledge map comprising the steps of:
getting a plurality of electronic chapters;
sequencing the plurality of electronic chapters to get a knowledge node sequence list and saving the knowledge node sequence list into a memory while the electronic chapters and a plurality of knowledge nodes of the knowledge node sequence list are connected by hyperlinks; and
compiling a list property of the knowledge node sequence list and a plurality of node properties of the knowledge nodes.

2. The device as claimed in claim 1, wherein the electronic chapters are a plurality of electronic books or are obtained from dividing a plurality of electronic books.

3. The device as claimed in claim 2, wherein the electronic books are produced by using a scanner to scan a plurality of physical books.

4. The device as claimed in claim 1, wherein the knowledge nodes are connected to at least one explanation information by hyperlinks; the explanation information is a text explanation, an audio explanation or a video explanation.

5. The device as claimed in claim 1, wherein at least one mark information or at least one note information is stored in the memory; the mark information or the note information is hyperlinked to the knowledge nodes.

6. The device as claimed in claim 1, wherein at least one discussion information, at least one question information, or at least one answer information is stored in the memory; the discussion information, the question information or the answer information is hyperlinked to the knowledge nodes.

7. The device as claimed in claim 1, wherein the list property includes a permission property while at least one permission information is stored in the memory; the permission information is in contrast to the permission property so as to read the knowledge node sequence list.

8. The device as claimed in claim 7, wherein a progress information is converted into the permission information.

9. The device as claimed in claim 8, wherein the list property includes a frequency property.

10. The device as claimed in claim 1, wherein the knowledge node is a sub-knowledge node sequence list with a sub-list property and the sub-knowledge node sequence list includes a plurality of sub-knowledge nodes.
